(19) United States
(12) Patent Application Publication
(10) Pub. No.: US 2014/0108383 A1
(43) Pub. Date: Apr. 17, 2014

(54) Method and System for Filtering Search Results for Maps Using Social Graph

(71) Applicant: Xtreme Labs Inc., Toronto (CA)

(72) Inventors: Boris Kai-Tik Chan, Toronto (CA); Kok King Tony Wong, Toronto (CA); Joshua Winters, Toronto (CA); Gregory Robert Burgoon, Toronto (CA); Nathan Sentjens, London (CA)

(73) Assignee: Xtreme Labs Inc., Toronto (CA)

(21) Appl. No.: 14/049,824

(22) Filed: Oct. 9, 2013

Related U.S. Application Data
(60) Provisional application No. 61/795,385, filed on Oct. 16, 2012.

(51) Int. Cl. G06F 17/30

(52) U.S. Cl. CPC G06F 17/30699
USPC 707/722

(57) ABSTRACT

A method is provided for selectively displaying locations on a map based on a user's social graph. Place references are aggregated from a plurality of applications on the device. The user's social graph is obtained from a social network. Socially relevant place references are determined by parsing the place references to identify participant references and matching at least one participant reference in a place reference to a relevant participant on the user's social graph. When a search request for a location is received on the device, the location results are filtered to only those results matching a socially relevant place reference. These filtered location results are displayable on a map. A programmed mobile device is also provided for carrying out the method.

### CROSS-REFERENCE TO RELATED APPLICATIONS

This application claims the benefit of U.S. Provisional Patent Application No. 61/795,385, filed Oct. 16, 2012 and entitled “System and Method for Filtering Search Results for Maps Using Social Graph”, which is incorporated herein by reference in its entirety.

### FIELD OF INVENTION

The field of invention is generally related to mobile devices for example Smartphones and in particular to filtering search results for maps using social graph and device data.

### BACKGROUND

Existing mobile devices e.g. phones, Smartphones, tablets and the like, have a multitude of functions that provide connectivity and communications services to a user. Such devices are used for making phone calls, checking e-mail, getting directions, playing games, searching the web, searching for places of interest on a map, amongst a host of other things.

The prior art lacks in a number of areas and improvements can result in an enhanced user experience thus providing increased efficiency and ease of use. When a user searches for a point of interest (POI) on a mapping application, the search results are generic and not necessarily helpful to the user. Irrespective of who performs the search query, the results will be the same or similar.

When the search results are presented on a map to the user in a user interface, in order to take further actions with those search results e.g. making a phone call or sending a text message, the user is required to switch to other applications. Thus information that may be available on the map may be required to be manually copied and pasted from the map application to the other application(s). This process requires several additional steps and is prone to error, thus reducing the quality of the user experience.

Therefore we note that prior art methods have inherent limitations. Accordingly, there is a need for providing an improved user experience by filtering the map search results using social graphs and data stored on mobile devices and presenting a list of actionable items relevant to the search and its results in the same user interface.

### SUMMARY OF THE INVENTION

Systems and methods are provided to filter the raw search results for locations on a map when using mobile devices by using social graph and device data as a filtering mechanism and additionally to provide a list of actionable items relevant to the search and the results which can be acted upon from the same user interface.

A preferred embodiment of the invention provides a method for filtering raw search results data using social graph for creating personal relevance to narrow down the search results when using mobile devices. The social graph information may be retrieved from the social network as needed or may be downloaded once, stored locally and periodically updated. The search results are displayed on a map and narrowed down using the social graph information. The social graph of a user can be acquired from the social network that a user prefers e.g. Facebook. Additionally, data in the different applications on the mobile device may also be used for augmenting and narrowing down the results.

In alternate embodiments the filtering process may be done entirely on the server, entirely on the mobile device or a combination of both server and mobile device. Additionally the user may also be able to create and augment a profile defining preferences and that information may be used to narrow down the search results before being sent to the mobile device.

Furthermore a set of actionable items may be provided to the user in the same user interface on a mobile device. This set of actionable items is relevant to the search, its results and the capabilities of the mobile device. Thus socially relevant results are displayed on a map using the same UI to initiate a series of actionable items e.g. inviting friends, initiating an IM conversation with a friend, calling the place (search result/point of interest) to make a booking, get directions to the place from the current location or future location, book an appointment in the calendar, mark as favourite, like on Facebook, etc. These items take into account the persons, locations and likes/dislikes of the user on the social network into consideration. Thus for different users, situations and operating contexts this list of actionable items may be different.

The system may also have a feedback loop such that the more searches are performed, the better the system gets as it gathers more information about the user. Additionally it may also learn from the results and the actions taken on those results by the user, and thus develop a sense of the user's habits, routines and preferences.

The system and method for filtering raw map search results uses the information aggregated from the social graph of the user and the information extracted from the applications installed in the mobile device, thus offering a more narrow and more socially relevant set of search results while also offering a set of actionable items in the same user interface, thus improving the user interaction and offering a more efficient way of interacting with these devices.

In particular, according to a first aspect of the invention, a method is provided for selectively displaying locations on a map based on a user's social graph. The method uses a programmed computing device to automatically carry out each of the steps. Place references are aggregated from a plurality of applications on the device. The user's social graph is obtained from a social network and stored. The social graph has nodes that identify participants (the user is also a participant). Socially relevant place references are determined by: parsing the place references to identify participant references; and matching at least one participant reference in a place reference to a relevant participant on the user's social graph. When a search request for a location is received and location results are obtained, the location results relating to socially relevant place references are identified. An interface is provided through which the socially relevant location results can be displayed on a map with an indication that the result is socially relevant. In one aspect of the invention, location results are filtered to only those results matching a socially relevant place reference, and only those filtered results are displayed.

At least one of the filtered locations may be a home or workplace of a participant in the user's social graph. At least one filtered locations may be a location liked, favorited or positively reviewed by a participant in the user's social graph. At least one of the filtered locations is a location mentioned in a status or profile of a participant in the user's social graph. At least one of the filtered locations may be a location mentioned in the user's status or profile.

Preferably, the nodes include information, and the information from the user's social graph and the aggregated place references are displayable together with the filtered location results on the map. For example, the information may include a relationship between the participant identified in the node and the user. The user may select to display only location results wherein the related participants have a particular relationship to the user. For example, the user may select to only display location results related to the user's friends on the social graph (or persons with X degrees of separation from the user on the social graph, family members, co-workers, etc.).

The information may include reviews of the locations by participants. The information may include comments about the locations by participants. The information may include past, present or future calendar entries or activities of the user or other participants mentioning the location.

Preferably, the filtered location results are further displayed with actionable items. Examples of actionable items include:
a link to call the location;
a link to directions to the location (the method may include detecting the current location of the user, in which case, the directions are directions from the detected current location);
a link for making an online reservation at the location;
a link for setting a calendar appointment to attend at the location;
a link for purchasing or reserving tickets to attend an event at the location;
a link to invite someone to attend with the user at the location.
a link to launch an app (either related to one of the above functions or any other kind of app whatsoever).

Preferably, the list of actionable items is itself tailored. The actionable items to be displayed may be selected based on at least one of: user past behaviour tracked on the device, user stated preferences, and probabilistically most-likely courses of action based on a detected operating context of the device. The operating context may include data received from sensors on the device (e.g. detecting by device accelerometer and/or GPS whether the user is on the go or stationary, or determining from GPS location and known data whether the user is at home or at work or travelling).

Preferably, the interface displays on the map at least one photograph associated with a participant from the participant's node on the social graph, and/or at least one photograph associated with a place reference associated with that participant.

According to a second aspect of the invention, a programmed mobile device is provided for selectively displaying locations based on a user's social graph. The device preferably has resident software programmed for carrying out steps of the above methods. In one preferred embodiment, the social graph is at least temporarily stored on the mobile device. Alternatively, the social graph may be remotely stored and accessible by query from the mobile device. Information from the social graph may be stored in a superset with the aggregated place references.

### BRIEF DESCRIPTION OF THE FIGURES

FIG. 1 is a flow diagram illustrating the primary steps of the method, according to a preferred embodiment.

FIG. 2 is a flow diagram illustrating another embodiment of the method specifically taking into account the user's current location.

FIG. 3 is a flow diagram illustrating tailoring of the actionable items based on a scenario and device capabilities.

FIG. 4 is a conceptual diagram of a people centric method of organizing and aggregating device information.

FIG. 5A is a view of the user interface including map on which filtered search results are displayed.

FIG. 5B is a view with detail popup on location 502b.

FIG. 5C is a view with further detail on location 502b with actionable items and further information taken from the user's social graph.

FIG. 6 is a schematic diagram of the notional software stack on a sample computing device (e.g. mobile device).

### DETAILED DESCRIPTION

Before embodiments of the invention are explained in detail, it is to be understood that the invention is not limited in its application to the details of the examples set forth in the following descriptions or illustrated drawings. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation of the invention.

It should also be understood that many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, PHP, Perl, Python and Ruby are examples of dynamic languages. Additionally computer code may also be written using a web programming stack of software, which may mainly be comprised of open source software, usually containing an operating system, Web server, database server, and programming language. LAMP (Linux, Apache, MySQL and PHP) is an example of a well-known open-source Web development platform. Other examples of environments and frameworks using which computer code may also be generated are Ruby on Rails which is based on the Ruby programming language, or node.js which is an event-driven server-side JavaScript environment.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A device that enables a user to engage with an application using the invention, including a memory for storing a control program and data, and a processor (CPU) for executing the control program and for managing the data, which includes user data resident in the memory and includes buffered content. The computer may be coupled to a video display such as a television, monitor, or other type of visual display while other devices may have it incorporated in them (iPad). An application or a game or other simulation may be stored on a storage media such as a DVD, a CD, flash memory, USB memory or other type of memory media or it may be downloaded from the internet. The storage media can be inserted to the console where it is read. The console can then read program instructions stored on the storage media and present a user interface to the user.

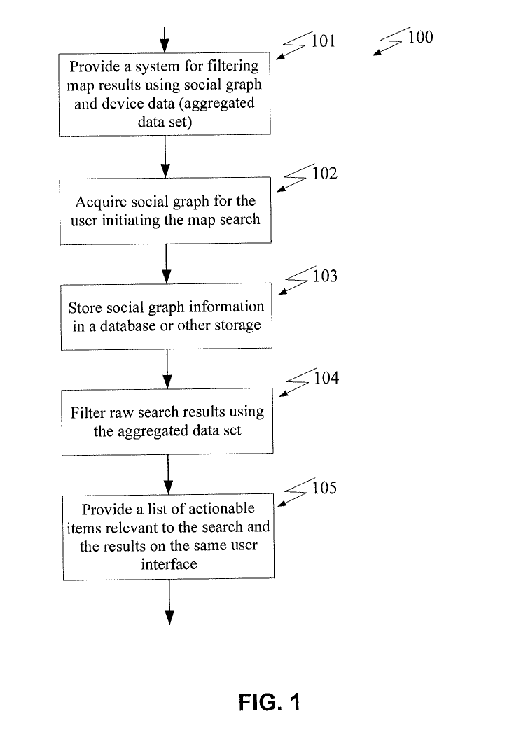

FIG. 1 is a flow diagram of the primary steps of the method, according to a preferred embodiment. A system is provided for filtering raw map search results using social graph and mobile device data (collectively referred to as the aggregated data set) 101. In the preferred embodiment of the invention the system and method may be implemented on a mobile device like a Smartphone, a tablet or the like and the social graph of the user initiating the search acquired from a social network like Facebook and the device data gathered from the different applications installed on the said device. Collectively the information/data gathered from the social graph of the user and the device data which is acquired from the different applications installed on the mobile device are referred to as the aggregated data set.

The social graph is acquired for the user initiating the search 102 by connecting to a social networking website. A social networking service is an online service or a platform or a website that provides the means for people to build their social networks reflecting their social relationships with other people. Typically a social network service consists of a representation of each person via a profile, each person's social connections and their interests. Today most social networking services are web-based and also provide means for people to interact with each other through e-mail, instant messaging, online chats etc. Social networking websites allow people to share ideas, activities, events, and interests within their individual networks.

Facebook, Twitter, LinkedIn and Google+ are examples the most popular social networking websites. Social networking websites share a variety of technical features. The most basic of these are visible profiles usually with a list of “friends” who are also users of the site. Some social networking websites allow people to upload pictures, add multimedia content to uniquely individualize the look and feel of their profiles. Facebook even allows people to enhance their profiles by adding modules or applications.

Profiles often have a section dedicated to comments from friends and other users. To protect user privacy, social networks typically have controls that allow users to choose who can view their profile, contact them, add them to their list of contacts, and so on.

In mathematics a graph is an abstraction for modeling relationships between things. A graph consists of nodes and edges, or things and the ways that these things relate to each other.

With the recent rise and proliferation of social networks, the social graph comes into the spotlight. A social graph is a representation of the interconnection of relationships in an online social network. A social graph is a mapping of people and how they are related or connected to other people. In a social graph, each person is a node. There is an explicit connection, if two people know each other, for example, two people can be connected because they work together or because they went to school together or because they are married. The links between people in social networks are of different types; and the different types of relationships can be a friend, a co-worker, a family member, a classmate, a schoolmate etc.

There may be at least two kinds of relationships; one-way relationships and two-way relationships. An example of a one-way relationship is a person subscribing or following a celebrity. In this kind of relationships one the person subscribing or following needs to start the relationship. An example of a two-way relationship is a person sending a “friend” request to another person, and the second person then confirming the “friend” request before the relationship is established. Thus in a two-way relationship if the recipient of the “friend” request does not confirm this request there is no relationship between the two people in the social graph.

It should be noted that the invention is not dependent on a live connection to the social network all the time to function; instead the social graph once acquired can be harvested for information and this additional information may be used to supplement and augment the information on the device and then also used for filtering the raw map search results.

In one embodiment of the invention a social networking website provides a social graph; for example Facebook offers a social graph that represents people and the connections they have to other people or things that they may care about. Facebook offers a well documented and established API, the Graph API, which presents a simple, consistent view of the Facebook social graph, uniformly representing objects in the graph (e.g., people, photos, events, and pages) and the connections between them (e.g., friend relationships, shared content, and photo tags). The Graph API as such allows a developer/application to access all public information about an object. The Graph API allows an application to read properties and connections of the Facebook social graph. A developer can use the API to read specific fields, get pictures of any object, introspect an object for metadata and get real-time updates on any changes.

To get this context sensitive information about a user that is not publically available, a developer/application must first get their permission. To get this private information that is not publically available, an application must get an access token for the Facebook user. After obtaining the access token for the user, the application can perform authorized requests on behalf of that user by including the access token in the Graph API requests.

Every object in the social graph has a unique ID. A developer can access the properties of an object by sending a secure request using the URL https://graph.facebook.com/ID. Additionally, people and pages with usernames can be accessed using their username as an ID. All responses to these requests are sent as JSON objects.

All of the objects in the Facebook social graph are connected to each other via relationships. A developer can examine the connections between objects using the URL structure https://graph.facebook.com/ID/CONNECTION_TYPE.

The Facebook Query Language (FQL) object enables running FQL queries using the Graph API. Facebook Query Language enables a developer to use an SQL-style interface to query the data exposed by the Graph API. It provides for some advanced features not available in the Graph API, including batching multiple queries into a single call.

Friendlist

Query this table to return any friend lists owned by the specified user.

friendlist_member'

Query this table to determine which users are members of a friend list.

The social graph information is stored in a local database or other data storage e.g. a file 103. The file storage may be local on the device, or on a remote server accessible over a network or a combination of local storage and remote storage.

The data storage is such that it is easily accessible by other applications installed on a device. This may be achieved by providing an API to this aggregated information so that other applications may also easily access this information. Devices where invention can be advantageously implemented may include but not limited to an iPhone, iPad, Smartphones, Android phones, personal computers e.g. laptops, tablet computers, touch-screen computers running any number of different operating systems e.g. MS Windows, Apple iOS, Linux, Ubuntu, etc.

In some embodiments, steps 102 and 103 may be repeated as often as necessary to keep the social graph up to date. Thus for example in one embodiment steps 102 and 103 may be repeated once a day while in another embodiment they may be repeated hourly. In this disclosure the term harvested implies extraction of relevant information from a larger set of data. Thus relevant information is extracted from the social graph since not all information contained in the social graph may be of use.

In some embodiments, the device is portable. In some embodiments, the device has a touch-sensitive display with a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive display. In some embodiments, the functions may include providing maps and directions, telephoning, video conferencing, e-mailing, instant messaging, blogging, digital photographing, digital videoing, web browsing, digital music playing, and/or digital video playing. Instructions for performing these functions may be included in a computer readable storage medium or other computer program product configured for execution by one or more processors.

Raw map search results are filtered using the aggregated data set 104. The social graph of the user can be acquired from the social networking website e.g. Facebook while the device data may be acquired from the various applications installed on the device.

A list of actionable items 105 may be provided to the user in the same user interface. For example, the system may provide a way for the user to invite friends, send a text, initiate an IM conversation, make a phone call to do a booking (for example be able to call the restaurant that is narrowed down in the search using the using the number that is provided in the search result), create an event in the calendar etc. This list of actionable items may be selected based on the search, the results of the search and the capabilities of the device and may vary from one situation to another and depend for example on detected patterns in the user's habits, routines and preferences, and the operating context of the device.

In alternate embodiments the filtering process may be done entirely on the server, entirely on the mobile device or a combination of both server and mobile device. For example in one embodiment the filtering using the user's social graph may be done on the server and the filtering using the device data may be done locally on the mobile device. One benefit of filtering using the device data locally on the mobile device is that there may be additional information about the users, their social graph, contacts, calendar, location, presence that can be used when presenting the final results of the filtering.

Additionally the user may also be able to create and augment a profile on the server defining preferences and that information may be used to narrow down the raw search results before being sent to the mobile device. Thus a user may define in the profile his like/dislikes for example the user may state that he is vegetarian. Thus when the search results are gathered, they take into account this profile and only vegetarian restaurants are displayed on the map.

The system may preferably also have a feedback loop such that the more searches are performed, the better the system gets as it gather more information about the user. Additionally it may also learn from the results and the actions taken on the actionable items that were presented to the user on the map.

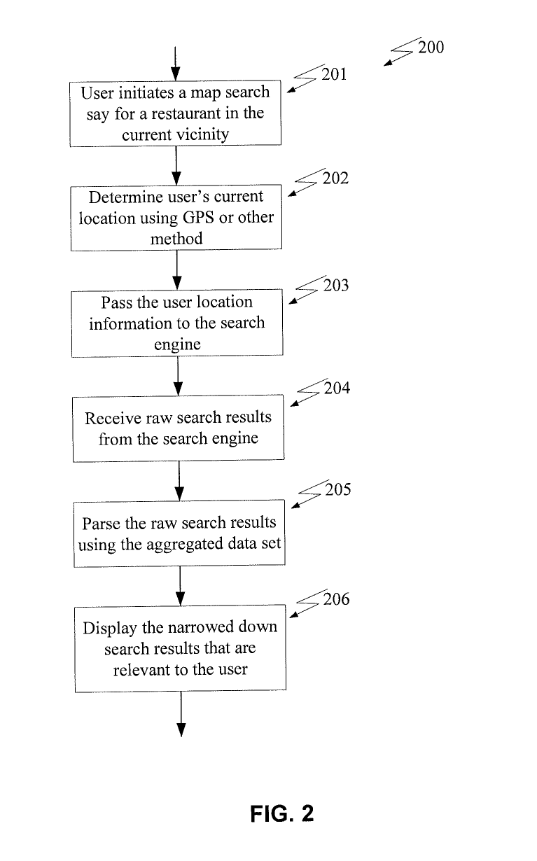

FIG. 2 shows one embodiment of the invention. When a user initiates a map search (such as for a restaurant) in the current vicinity 201, the user's current location may be determined (using GPS or other method) 202. The user location information can be passed to the search engine (as is generally well-known) 203. Once the raw search results from the search engine 204, these can be parsed using the aggregated data set which may be composed of the user's social graph and device data 205. The filtering may take into account the relationships defined in the social graph. For example, Facebook defines relationships like friends, family, colleagues, etc. The closeness of the relationship may have a factor in determining the weight that is provided when scoring relevance. Thus close friends and family may have a larger influence in determining the social relevance as compared to acquaintances.

In other embodiments of the invention the filtering process may take place entirely on the server, entirely on the mobile device or a combination of both the server and the mobile device.

In one embodiment of the invention the user may be able to define a profile on the server. Thus the results may be pre-filtered using this profile. In an alternate embodiment of the invention this profile may be associated with the mobile device of the user without requiring the user to create a profile. Thus searches done using this mobile device and their results and the actions taken on the actionable items are stored on the server, and this information may be used to pre-filter the raw data to make the results more personal.

The logic of how people are related to each other may be derived from the social graph of the user. In one embodiment, when the explicit relationship information may not be available from the social graph, such information may be inferred from other information that may be available. For example the persons who may share the same domain in their e-mail addresses may be considered as colleagues when such domain is not one provided by the free e-mail providers for example google.com or yahoo.com etc.

Relationships like family, friend, close friend, acquaintance etc. can be inferred from the social graph, by association with a list, group or circle in a social graph, by presence on specific address book contact lists, and filtering can start/end with time and other means e.g. specific events like long weekend, holidays, birthdays etc.

The above sets are exemplary and not limiting and other embodiments of the invention may use any other relationships to categorize these sets of device event information.

The narrowed down search results that are relevant to the user are then displayed 206 on the map.

Optionally, as a next step, the system may provide a list of actionable items in the same user interface. This list of actionable items is dependent on the user's search, its results and the device capabilities and the operating context. Additionally as an option if the search results happen to be highly socially relevant the most probable actionable items may be escalated or highlighted to encourage the user to take these options.

There are several possibilities in terms of the search results quality; the most obvious ones are listed below:
Highly relevant search results from the user social network (e.g. a friend visited the restaurant and provided comments). This can be determined from the social graph information e.g. Joe's Facebook status shows “Joe and friends had a fun time at Pops Pizza, the food and the ambiance were great”
Moderately relevant results from the user social network (e.g. a friend visited the restaurant but did not provide any comments). This can be determined from the social graph information e.g. Joe's Facebook status shows “Joe was at Pops Pizza”
No socially relevant search results at all; i.e. none of the people in the social network have any relevance to the results. In such a scenario, use prior art methods to provide search results

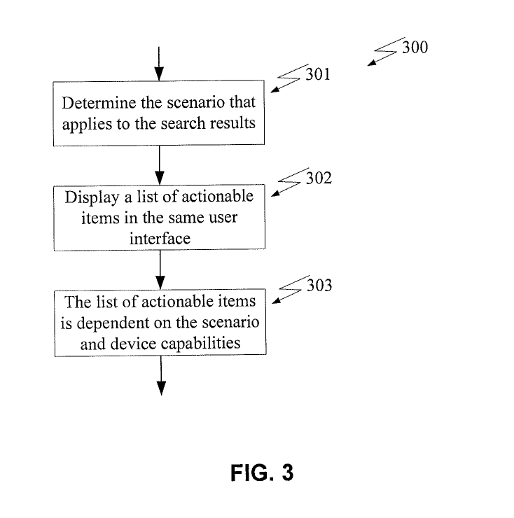

FIG. 3 shows one embodiment of the invention. The system determines the scenario that applies to the search results 301; i.e. are the results highly socially relevant, or moderately socially relevant or not socially relevant at all.

Based on the scenario of the search results quality, a list of actionable items can be displayed in the same user interface 302.

The list of actionable items can be dependent on the scenario of the search result quality (e.g. one of the exemplary scenarios presented above) and the device capabilities 303.

For example if the search results are highly socially relevant then the system may provide actionable items such as making a reservation, inviting a friend, setting an appointment in the calendar etc.

If the search results are moderately socially relevant, e.g. a friend from the social network visited a place but did not provide any reviews or opinions then the set of actionable items may include options such as calling the friend, sending a text message to the friend asking for opinion, starting an IM conversation to get more information about the place etc.

If the search results are not at all socially relevant, then the actionable items may include asking friends in the social network if anyone has been to this place and how was their visit, such as by posting a question in the “status” on Facebook, or in a forum etc.

The filtering, display and actionable items may also depend on the operating context. Sensors and other input from the device derived at the OS/Platform level (or interpreted by abstractions provided at that level) can help provide context into the activity of a user (e.g. accelerometer and GPS data can be interpreted to show a user is walking). Access to this type of data for interpretation can further provide context-specific filters.

For example, sensors may be used for determining when a user is walking as opposed to driving, and the results may be filtered appropriately. Time of day and day of the week may also be relevant. The calendar information that may be available on the device, and the user's location are factors that can be used in refining the search and presenting the results. For example, taking into account that it is a Tuesday when the user is at work and visiting a downtown office, the system may highlight search results of restaurants close to the user and the user's friends or colleagues who are available for lunch.

Looked at another way, the system considers the user's express or inferred intent at several stages in the search process: (i) pre-search (operating context and historical searches and patterns); (ii) during search (from the user's choice of search terms and the present operating context); and (iii) display stage (when the user selects a particular actionable item, thus demonstrating intent). From an analysis of these demonstrations of intent, the system can learn and in future better predict what the user wants under particular circumstances.

Intent may be captured before an action takes place, thus filters/context may relate to what users are doing or have done earlier; for example walking in a neighbourhood with restaurants, previously having searched for restaurants, a place where a user may frequent for food etc.

Intent may also be captured during an action. For example, a user may be searching for a “Japanese restaurant” (by typing text into a search box, using a voice command, etc.).

Intent may be captured by actionable items. For example, if a restaurant provides a phone number that a user can use to call, then when the user clicks that actionable item, the system may infer that the user is trying to make a reservation.

These demonstrations of intent can be used to provide filtering of map searches to provide better results.

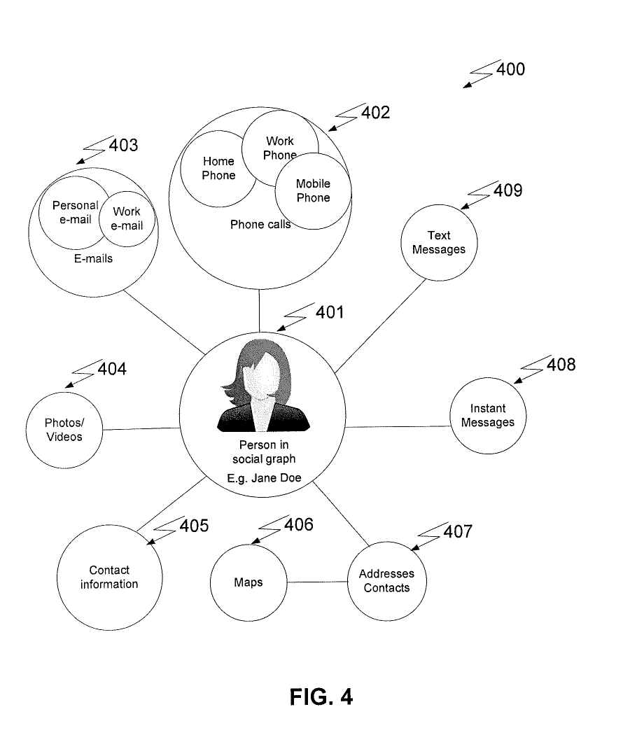

FIG. 4 shows how in one embodiment of the invention a people centric view of the device events information filtered using the social graph may be organized. In this example, the device events information may be notionally organized around a person Jane Doe 401. All the device event information that was found on the user's device relating to Jane Doe 401 may thus be captured in a holistic way and may be used for filtering the raw search results pertaining to maps.

All the phone calls both to and from Jane Doe 402 whether they have been made or received at the home phone, work phone or mobile phone can be grouped together.

All the e-mails both to and from Jane Doe 403 whether they have been sent or received from personal e-mail account or work e-mail account can be grouped together.

All the photos/videos both sent to and received from Jane Doe or photos and videos that have her in them 404 can be grouped together.

All contact information items that relate to Jane Doe e.g. home phone number, office phone number, mobile phone number, work e-mail address, personal e-mail address, home address and office address etc. can be grouped together 405.

All addresses for example Jane Doe's home address, office address and cottage address etc. can be grouped together 407. All maps related to these addresses 407 can be grouped together 406. This may also include directions to these addresses from the user preferred starting address for example home address.

All instant messages (IM) sent and received from Jane Doe can be grouped together 408.

All text messages (SMS) and multimedia messages (MMS) that have been sent to or received from Jane Doe can be grouped together 409.

Device events can include but are not limited to call logs, which may include calls received, calls made, calls missed etc.; Text Messages received, sent etc. e-mails sent, received, drafts, etc. IM communications including conversations and files exchanged, camera photos and their related metadata e.g. geo-location, time and date, settings, subjects etc.; contacts. This list is exemplary and not limiting.

Similar to FIG. 4, all information about all other members of the social network of the user can also be organized or aggregated in the same fashion. Thus relevance of the final map search results may also be narrowed down using the device events (aggregated data set).

Some examples of the Google Android API calls that may be used in this process to acquire the device events are given below:

TelephonyManager

Provides access to information about the telephony services on the device. Applications can use the methods in this class to determine telephony services and states, as well as to access some types of subscriber information. Applications can also register a listener to receive notification of telephony state changes.

SmsManager

Manages SMS operations such as sending data, text, and pdu SMS messages. Get this object by calling the static method SmsManager.getDefault( )

STATUS_ON_ICC_READ: Received and read text messages

STATUS_ON_ICC_SENT: Stored and sent text messages

CallLog: The CallLog provider contains information about placed and received calls. Using this class and CACHED NAME: The cached name associated with the phone number can be obtained.

CallLog.Calls: Contains the recent calls.

The device events information can be stored in a database or other local storage on the device while preferably exposing an API to this stored information. Thus other applications may use this information using this particular API to gain access to this stored information.

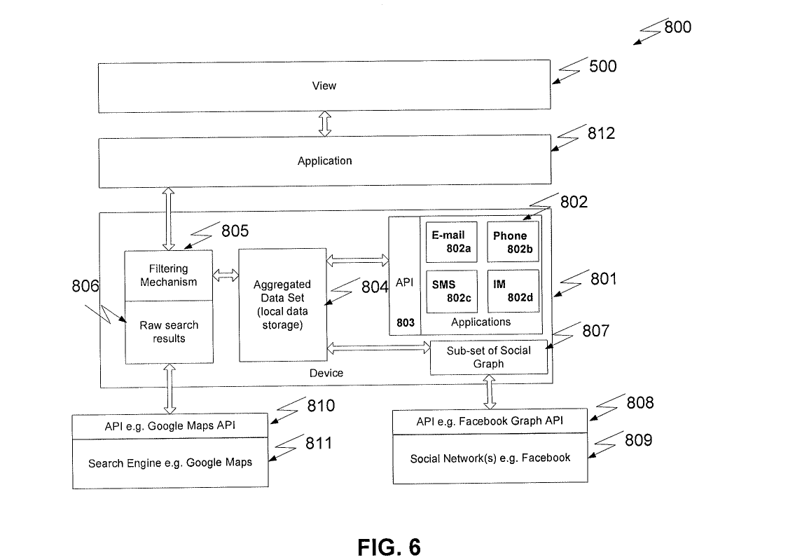

It should be noted that the social graph data is part of the aggregated data set (Refer to FIG. 6, 804). The data acquired from the social graph is used to enhance the information that is available in the device. Information like names, birthdays, anniversary, likes, other e-mail and contact information etc. that is acquired from the social graph complements the already available information in the device. This data set acquired from the social graph also provides an extra context e.g. friend lists, photos, etc. that may not exist on the device. Thus the aggregated information includes both the data set from the social graph as well as the data set from the device. When the final context/filtering of the raw map search results is performed, it is much more useful since a more comprehensive data set has been used to filter this and make it more socially relevant.

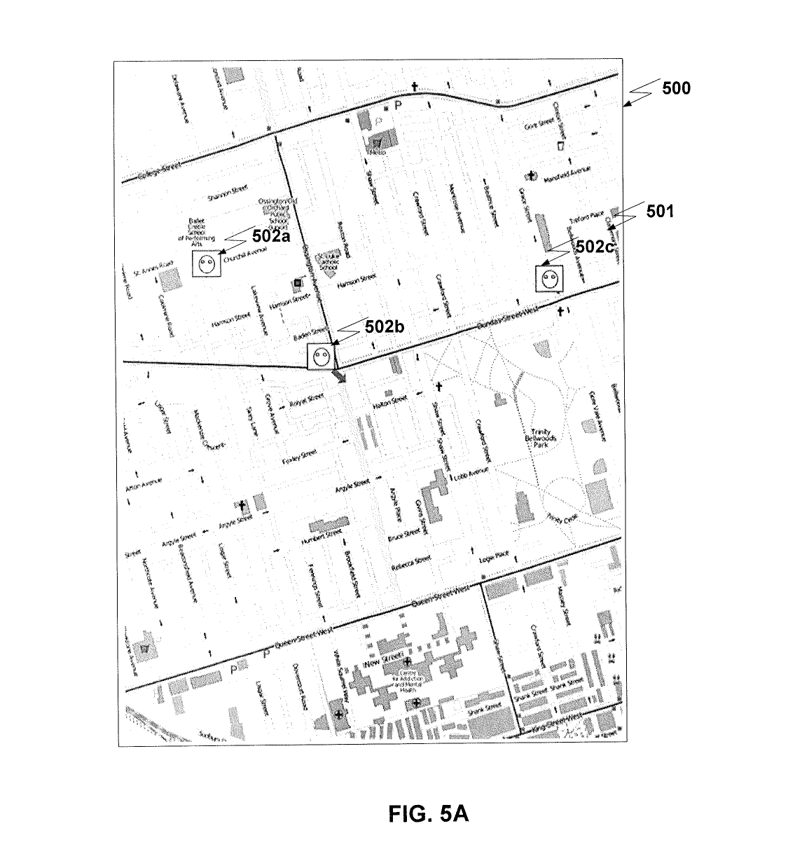

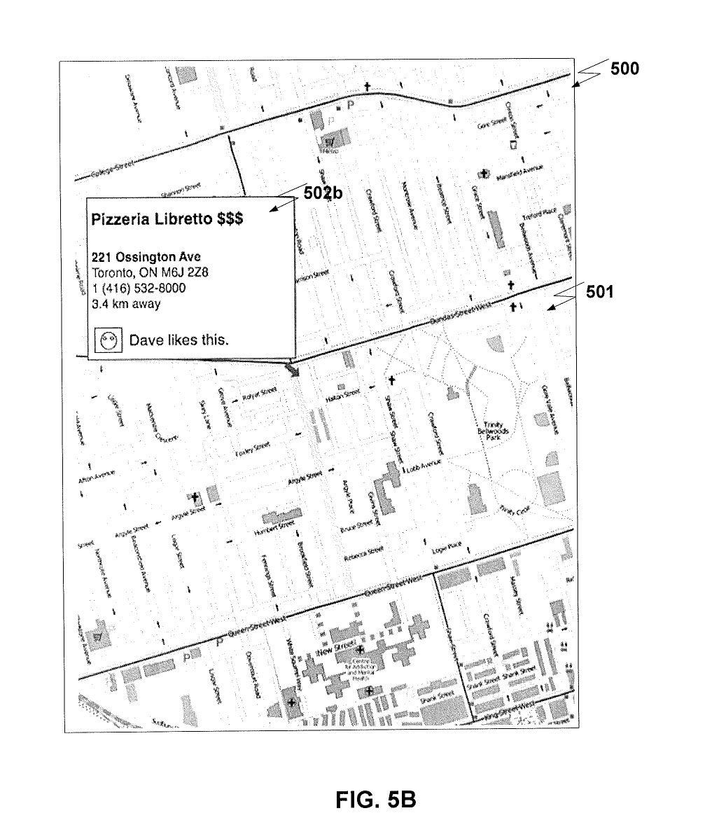

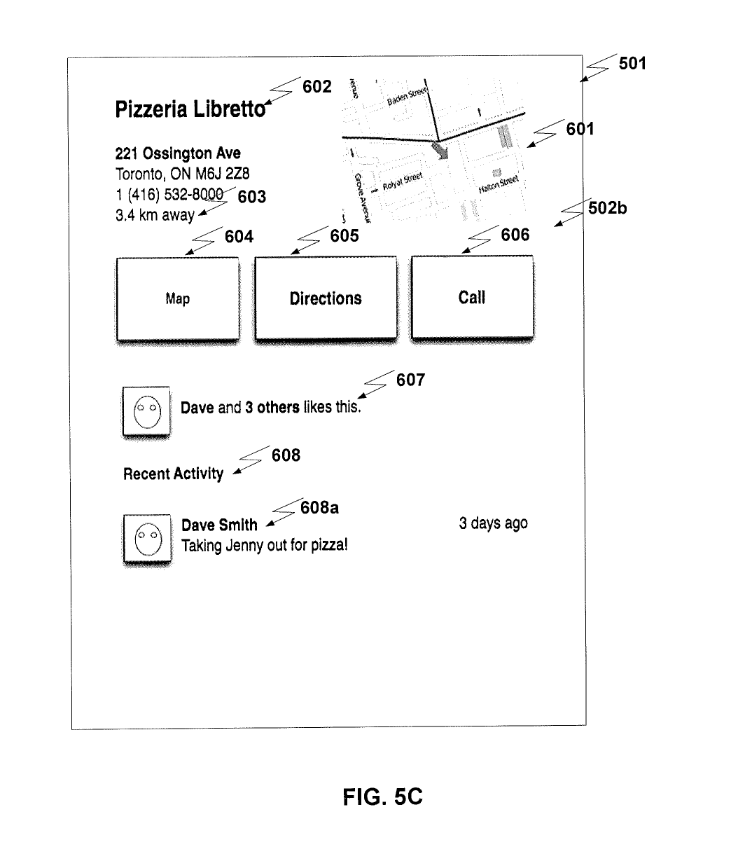

FIG. 5A shows the view 500 of the user interface which includes the map 501 on which the results of the search are displayed based on their location.

The most suited and socially relevant search results 502a, 502b and 502c are highlighted preferably with the thumbnail of the photo of the person from the social network due to whom this result is considered socially relevant.

FIG. 5B shows the view 500 of the user interface which includes the map 501 after the user has clicked on 502b in the FIG. 5A. Thus further information preferably like name of the restaurant, the average entree price, address and the details of the information that makes it socially relevant e.g. “Dave likes this” where Dave is a member of the social network of the person initiating the search, may be displayed at this point.

FIG. 5C shows the view 500 of the user interface which includes details when a user has preferably clicked on the highlighted search result 502b depicted in FIG. 5B. The user interface shows a thumbnail of the area map 601; the restaurant name 602; its address, phone number and approximate distance from the current location 603; a set of actionable items 604, 605, and 606. By clicking map 604 the detailed map of the area will be displayed. By clicking directions 605, the turn by turn directions to the restaurant from the current location will be displayed. By clicking call 606, a phone call to the restaurant can be initiated. Item 607 displays the information that makes this search result socially relevant (“Dave and 3 others like this”). Item 608 lists the recent activity in this case showing 608a that Dave Smith, who is a member of the social network of the person who initiated the search, visited the restaurant 3 days ago. This information has been inferred from Dave Smith's Facebook status (“Taking Jenny out for pizza!”) which can be harvested from the social graph.

FIG. 6 shows one embodiment of the invention, a schematic of the notional software stack. Device 801 may have multiple applications 802 including for example e-mail 802a, phone 802b, SMS 802c and IM 802d installed on it.

Device API 803 can be used to acquire the device event information from the different applications installed on the device. This extracted information is aggregated in say a database or other local data storage e.g. an XML file 804 on the device 801.

In the preferred embodiment of the invention, the information harvested from the social graph is part of the aggregated data set 804. The data acquired from the social graph is used to enhance the information that is available on the device. Information such as names, birthdays, anniversary, likes, other e-mail addresses and contact information, etc. that is acquired from the social graph complements the already available information in the device. This data set acquired from the social graph also provides an extra context e.g. friend lists, photos, etc. that doesn't exist on the device. Thus the aggregated information includes both the data set from the social graph as well as the data set from the device. When the final context/filtering is performed, the resultant is much more useful since a more comprehensive data set has been used, one acquired from two different and divergent sources.

A sub-set of the social graph 807 can be extracted from the social networking website 809 using the API 808 provided by the social networking website. In one embodiment the information extracted from the social graph may also be used to supplement the information obtained from the device. In an alternate embodiment the entire social graph may be acquired from the social networking site. This aggregated data set may then be stored in the local data storage (e.g. a database) 804.

When a user initiates a search from a map search application 812, this application may preferably use an API that is exposed from the filtering mechanism 805 that provides only socially relevant map results after filtering the raw search results.

The search from the map search application 812 may initiate a call to a search engine (e.g. Google Maps or the like) 811 using an API (e.g. Google Maps API or the like) 810. Other search engines and their APIs can also be used (e.g. Microsoft Bing).

The raw search results 806 provided by the search engine are preferably cached. Using the aggregated data set 804, which includes a sub-set of the social graph of the user and the information gathered from the various applications installed on the device, the raw search results can be filtered and presented to the requesting application 812 such that socially irrelevant information is left out and only socially relevant information is displayed.

The aggregated data set 804 (that includes the device event information and the information extracted from the social graph like posts by friends, places they visited, items and places that the liked, birthdays, anniversaries, additional contact information, photos etc.) can be stored in specialized databases and/or cache storage and is exposed via custom content providers and interfaces (AIDL).

In a similar way, when a user is presented with the list of actionable items, the relevance of this list is dependent on the search, its results, the information that is gathered from the social graph as well as the different application that are installed on the device and the device capabilities.

The information about the device capabilities can be gained using a few different methods. In one embodiment this information can be gained from WURFL (Wireless Universal Resource File) which is a global database of all devices and the API to tap that information programmatically. WURFL is a Device Description Repository (DDR), i.e. a framework that enables applications to map HTTP requests to a description of the capability of the mobile device that requests the page.

The WURFL is “an XML configuration file which contains information about capabilities and features of mobile devices” (http://wurfl.sourceforge.net/) and using an API can be queried for device capabilities.

The information about how to contact the members of the social network may be acquired from the aggregated data set 804, which may be a combination of information acquired from the social graph of the user as well as the information acquired from the different applications 802 installed on the device.

Some examples of different sets of actionable items that may be presented to the user in the same interface are given below. This list is exemplary and not limiting, the intent is to cover all such possibilities, combinations and permutations that may be useful and may be used for increasing the efficiency and ease of use:

make a reservation

call a place

ask a friend using text message

survey a group of friends

see photos of the place

look into packages (commerce/deals integration)

In one embodiment of the invention, the system may also learn from the results and the actions taken on the actionable items by the user. Thus if a user is initially given the actionable items of making a phone call and sending a text message to a friend, and the user has preferred to send text messages in a majority of cases, then the system may learn and subsequently only provide the actionable item of sending a text message while eliminating the actionable item of making a phone call.

In one embodiment of the invention the user may be able to create and define a profile. Alternately the profile may be associated with the mobile device. Thus all searches done, their results and the actions taken on the actionable items may be used to enhance the profile and aid in the filtering of the search results.

Similarly the system may also be able to aggregate the group behaviour i.e. the behaviour of the user and the associated social network may be captured. Thus this group behaviour may also be used to narrowing down the search results.

Facebook Platform uses the OAuth 2.0 protocol for authentication and authorization and supports two different OAuth 2.0 flows for user login: server-side (also known as the authentication code flow) and client-side (also known as the implicit flow). The server-side flow is used whenever an application needs to call the Graph API from its web server. The client-side flow is used whenever an application needs to make calls to the Graph API from a client, such as JavaScript running in a Web browser or from a native mobile or desktop application.

By default, the user is asked to authorize the application to access basic information that is available publicly or by default on Facebook. If an application needs more than this basic information to function, it must request specific permissions from the user. This is accomplished by adding a scope parameter to the OAuth Dialog request followed by comma separated list of the required permissions.

An application can access people and pages with usernames, where their username is an ID. Getting an access token for a user with no extended permissions allows an application to access the information that the user has made available to everyone on Facebook. If an application needs specific information about a user, like their email address or work history, it must ask for the specific extended permissions. The reference documentation for each Graph API object contains details about the permissions an application needs to access each connection and property on that object.

With a valid access token an application can invoke the Graph API by appending the access_token parameter to Graph API requests. If the user changes their password, the access token expires. An application can request a new access token by re-running the appropriate process.

It should be understood that although the term application has been used as an example in this disclosure but in essence the term may also imply to any other piece of software code where the embodiments of the invention are incorporated. The software application can be implemented in a standalone configuration or in combination with other software programs and is not limited to any particular operating system or programming paradigm described here. Thus, this invention intends to cover all applications and user interactions described above as well as those obvious to the ones skilled in the art.

The computer program comprises: a computer usable medium having computer usable program code, the computer usable program code comprises: computer usable program code for presenting graphically to the users options for scrolling via the touch-screen interface.

Several exemplary embodiments/implementations of the invention have been included in this disclosure. There may be other methods obvious to the ones skilled in the art, and the intent is to cover all such scenarios. The application is not limited to the cited examples, but the intent is to cover all such areas that may be benefit from this invention.

The device may include but not limited to a personal computer (PC), which may include but not limited to a home PC, corporate PC, a Server, a laptop, a Netbook, a Mac, a cellular phone, a Smartphone, a PDA, an iPhone, an iPad, an iPod, an iPad, a PVR, a settop box, wireless enabled Blu-ray player, a TV, a SmartTV, wireless enabled Internet radio, e-book readers e.g. Kindle or Kindle DX, Nook, etc. and other such devices that may be used for the viewing and consumption of content whether the content is local, is generated on demand, is downloaded from a remote server where is exists already or is generated as a result. Source Device where content is located or generated and Recipient Device where content is consumed may be running any number of different operating systems as diverse as Microsoft Windows family, MacOS, iOS, any variation of Google Android, any variation of Linux or Unix, PalmOS, Symbian OS, Ubuntu or such operating systems used for such devices available in the market today or the ones that will become available as a result of the advancements made in such industries.

The intent of the application is to cover all such combinations and permutations not listed here but that are obvious to persons skilled in the art. The above examples are not intended to be limiting, but are illustrative and exemplary.

The examples noted here are for illustrative purposes only and may be extended to other implementation embodiments. While several embodiments are described, there is no intent to limit the disclosure to the embodiment(s) disclosed herein. On the contrary, the intent is to cover all alternatives, modifications, and equivalents obvious to persons skilled in the art.

As can be seen from the above descriptions, the invention provides a system and method for filtering raw map search results using the information aggregated from the social graph of the user and the information extracted from the applications installed in the device, thus offering a more narrow and more socially relevant set of search results and also offering a set of actionable items in the same user interface, thus improving the user interaction and offering a more efficient way of interacting with these devices.

What is claimed is:

1. A method of selectively displaying locations on a map based on a user's social graph, comprising using a programmed computing device to automatically carry out each of the following steps:
aggregating place references from a plurality of applications on the device;
obtaining and storing the user's social graph from a social network, the social graph having nodes that identify participants and in which the user is a participant;
determining socially relevant place references by:
parsing the place references to identify participant references; and
matching at least one participant reference in a place reference to a relevant participant on the user's social graph;
receiving a search request for a location and obtaining location results;
filtering the location results to identify those results matching a socially relevant place reference; and
providing an interface through which the filtered location results can be displayed on a map and identified as socially relevant.

2. The method of claim 1, wherein at least one filtered location is a home or workplace of a participant in the user's social graph.

3. The method of claim 1, wherein at least one filtered location is a location liked, favorited or positively reviewed by a participant in the user's social graph.

4. The method of claim 1, wherein at least one filtered location is a location mentioned in a status or profile of a participant in the user's social graph.

5. The method of claim 1, wherein at least one filtered location is a location mentioned in the user's status or profile.

6. The method of claim 1, wherein the nodes include information, and the information from the user's social graph and the aggregated place references are displayable together with the filtered location results on the map.

7. The method of claim 6, wherein the information includes a relationship between the participant identified in the node and the user.

8. The method of claim 7, wherein the user can select to display only location results wherein the related participants have a particular relationship to the user.

9. The method of claim 7, wherein the user can select to only display location results related to the user's friends on the social graph.

10. The method of claim 6, wherein the information includes reviews of the locations by participants.

11. The method of claim 6, wherein the information includes comments about the locations by participants.

12. The method of claim 6, wherein the information includes past, present or future calendar entries or activities of the user or other participants mentioning the location.

13. The method of claim 1, wherein the filtered location results are further displayed with actionable items.

14. The method of claim 13, wherein the actionable items include a link to call the location.

15. The method of claim 13, wherein the actionable items include a link to directions to the location.

16. The method of claim 15, further comprising detecting a current location of the user at the time of the search request, wherein the directions are directions from the user's current location to the location.

17. The method of claim 13, wherein the actionable items include a link for making an online reservation at the location.

18. The method of claim 13, wherein the actionable items include a link for setting a calendar appointment to attend at the location.

19. The method of claim 13, wherein the actionable items include a link for purchasing or reserving tickets to attend an event at the location.

20. The method of claim 18, wherein the link includes a link to invite someone to attend with the user at the location.

21. The method of claim 13, wherein the link includes a link to launch an app.

22. The method of claim 13, wherein the actionable items to be displayed are selected based on at least one of: user past behaviour tracked on the device, user stated preferences, and probabilistically most-likely courses of action based on a detected operating context of the device.

23. The method of claim 22, wherein the operating context includes data received from sensors on the device.

24. The method of claim 1, wherein the interface displays on the map at least one photograph associated with a participant from the participant's node on the social graph.

25. The method of claim 1, wherein the interface displays on the map at least one photograph associated with a place reference associated with that participant.

26. A programmed mobile device for selectively displaying locations based on a user's social graph, the device having resident software programmed for:
aggregating place references from a plurality of applications on the device;
obtaining and storing the user's social graph from a social network, the social graph having nodes that identify participants and in which the user is a participant;
determining socially relevant place references by:
parsing the place references to identify participant references; and
matching at least one participant reference in a place reference to a relevant participant on the user's social graph;
receiving a search request for a location and obtaining location results;
filtering the location results to identify those results matching a socially relevant place reference; and
providing an interface through which the filtered location results can be displayed on a map and identified as socially relevant.

27. The device of claim 26, wherein the social graph is at least temporarily stored on the mobile device.

28. The device of claim 26, wherein the social graph is remotely stored and accessible by query from the mobile device.

29. The device of claim 26, wherein information from the social graph is stored in a superset with the aggregated place references.
